(19) United States
(12) Patent Application Publication
(10) Pub. No.: US 2013/0001053 A1
(43) Pub. Date: Jan. 3, 2013

(54) TILT SWITCH

(76) Inventors: Xiao-Feng Li, New Taipei (TW); Li-Jun Xu, New Taipei (TW); Ming-Han Lin, New Taipei (TW); Wen-Tzao Yang, New Taipei (TW)

(21) Appl. No.: 13/174,764

(22) Filed: Jun. 30, 2011

(51) Int. Cl. H01H 35/02

(52) U.S. Cl. 200/61.52

(57) ABSTRACT

A tilt switch includes an insulating housing having a receiving chamber and a connecting cavity smaller than the receiving chamber in diameter to form a step therebetween, electrical terminals penetrating through the insulating housing to project into the connecting cavity, an insulating cover removably covered on the insulating housing, and a switching ball made of conductive materials and rollably placed between the insulating housing and the insulating cover. The step has a top face perpendicular to periphery surfaces of the connecting cavity and the receiving chamber. The switching ball needs to roll over the step having a hard span when the tilt switch changes working states between a closed state realized by the switching ball projecting into the connecting cavity to simultaneously connect with the electrical terminals, and an open state realized by tilting the tilt switch to disconnect the switching ball from at least one electrical terminal.

### BACKGROUND OF THE INVENTION

1. Field of the Invention

The present invention relates to a switch, and more particularly to a tilt switch.

2. The Related Art

A traditional tilt switch includes an insulating housing, a plurality of electrical terminals assembled in the insulating housing, a switching ball rollably placed in the insulating housing, and an insulating cover covered on the insulating housing to restrain the switching ball in the insulating housing. An inclined guiding slope of a ring shape is provided in the insulating housing for propping the switching ball when the tilt switch is at a closed state by means of simultaneously contacting with the electrical terminals, and guiding the switching ball to roll by means of tilting the tilt switch sideward so as to disconnect the switching ball from the electrical terminals and realize an open state of the tilt switch. However, in the condition of the tilt switch having a finite size, it is difficult to ensure the tilt switch steadily at the closed state or the open state only by means of the inclined guiding slope, and the switching ball is apt to randomly roll even if the tilt switch is tilted at a very little angle. As a result, the tilt switch has a bad operational reliability.

### SUMMARY OF THE INVENTION

An object of the present invention is to provide a tilt switch including an insulating housing. The insulating housing has a receiving chamber in an upper portion thereof and a connecting cavity in a lower portion thereof. The connecting cavity is coaxially connected with the receiving chamber and smaller than the receiving chamber in diameter to accordingly form a ring-shaped step between two vertical periphery surfaces of the connecting cavity and the receiving chamber. A bottom side of the connecting cavity defines a plurality of inserting holes each vertically penetrating through the insulating housing. A plurality of electrical terminals is inserted upward in the inserting holes respectively and further projects into the connecting cavity. A switching ball made of conductive materials is rollably placed in the receiving chamber of the insulating housing. An insulating cover is removably covered on the insulating housing to seal up the receiving chamber and restrain the switching ball in the insulating housing. The ring-shaped step has a top face substantially perpendicular to the two vertical periphery surfaces of the connecting cavity and the receiving chamber. The switching ball needs to roll over the ring-shaped step having a hard span when the tilt switch changes working states thereof between a closed state which is realized by the switching ball further projecting into the connecting cavity to simultaneously electrically connect with the electrical terminals, and an open state which is realized by tilting the tilt switch to disconnect the switching ball from at least one electrical terminal.

As described above, the switching ball of the tilt switch of the present invention needs to roll over the step which has a hard span when the tilt switch changes the working states thereof between the closed state and the open state. So, the working states of the tilt switch are not easily changed so that further improves operational reliability of the tilt switch.

### BRIEF DESCRIPTION OF THE DRAWINGS

The present invention will be apparent to those skilled in the art by reading the following description thereof, with reference to the attached drawings, in which:

FIG. 1 is an assembled perspective view of a tilt switch in accordance with an embodiment of the present invention;

FIG. 2 is an exploded perspective view of the tilt switch of FIG. 1;

FIG. 3 is a vertical view of an insulating housing of the tilt switch of FIG. 1;

FIG. 4 is a cross-sectional view of the insulating housing of the tilt switch of FIG. 1;

FIG. 5 is a cross-sectional view showing the tilt switch at a closed state; and

FIGS. 6-8 are cross-sectional views showing the tilt switch at there different open states.

### DETAILED DESCRIPTION OF THE PREFERRED EMBODIMENT

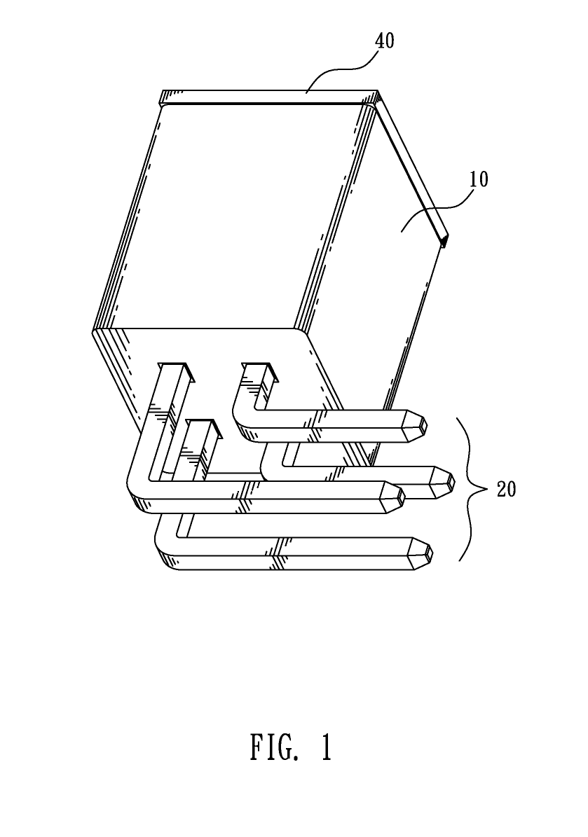

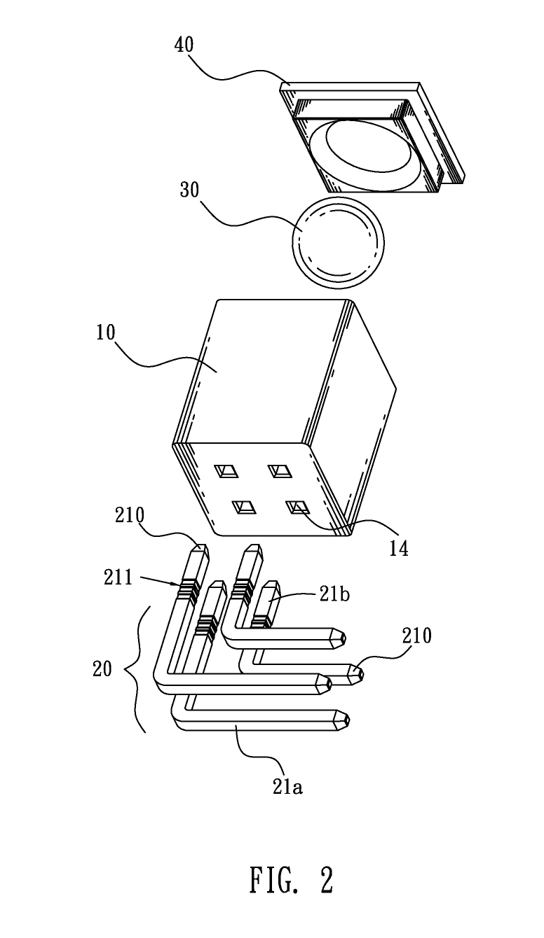

With reference to FIG. 1 and FIG. 2, a tilt switch according to an embodiment of the present invention includes an insulating housing 10, four electrical terminals 20 assembled in the insulating housing 10, a switching ball 30 rollably placed in the insulating housing 10, and an insulating cover 40 removably covered on the insulating housing 10 to restrain the switching ball 30 in the insulating housing 10.

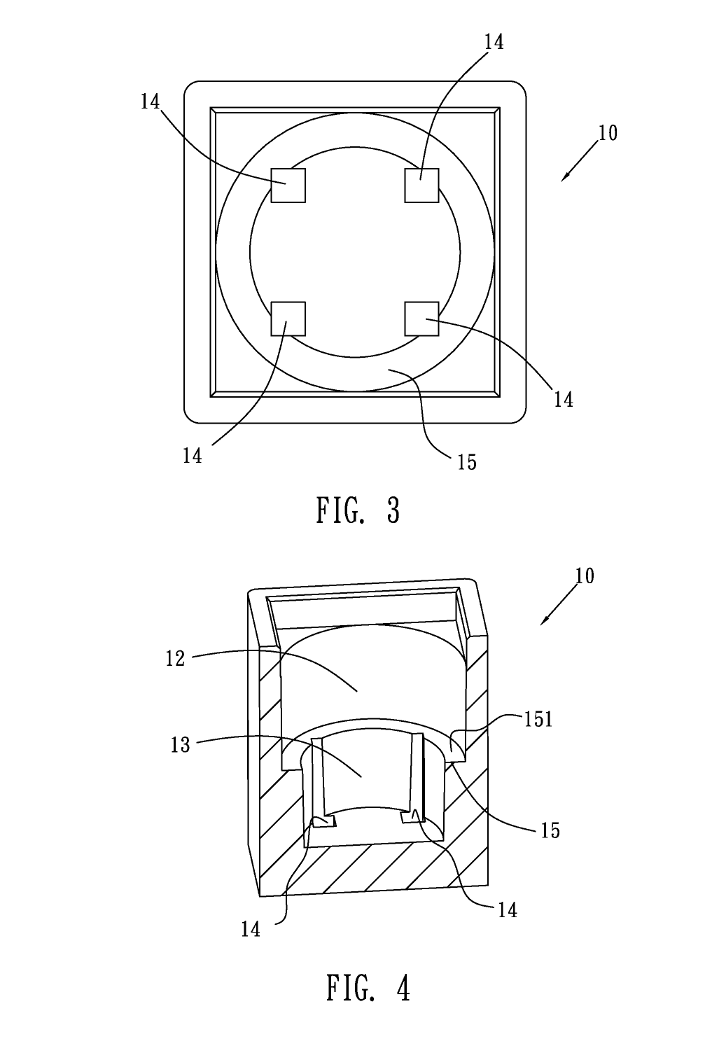

Referring to FIGS. 2-4, the insulating housing 10 is of a rectangular case shape with a columned receiving chamber 12 in an upper portion thereof and a columned connecting cavity 13 in a lower portion thereof. The receiving chamber 12 has a top opened freely. The connecting cavity 13 has a top connected with a bottom of the receiving chamber 12 and is coaxial with the receiving chamber 12. The connecting cavity 13 is smaller than the receiving chamber 12 in diameter to accordingly form a ring-shaped step 15 between two vertical cylindrical surfaces of the connecting cavity 13 and the receiving chamber 12, wherein the ring-shaped step 15 has a top face 151 perpendicular to the two vertical cylindrical surfaces of the connecting cavity 13 and the receiving chamber 12. A bottom side of the connecting cavity 13 is provided with a plurality of inserting holes 14 each extending vertically to penetrate through the insulating housing 10.

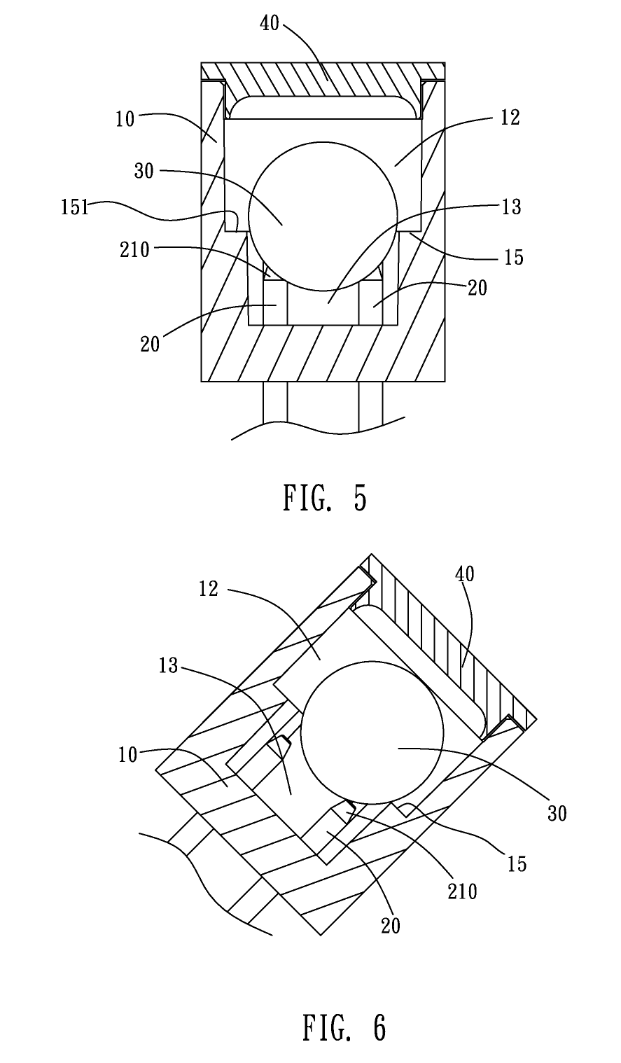

Referring to FIG. 1, FIG. 2 and FIG. 5, each of the electrical terminals 20 is of substantial L-shape and has two arms 21a, 21b of rectangular-column shape perpendicular to each other. Two free ends of the arms 21a, 21b are designed as a pyramid end 210 respectively. A vertical arm 21b of the electrical terminal 20 has a substantial middle portion thereof provided with fastening ridges 211 therearound. The vertical arms 21b of the electrical terminals 20 are inserted upward into the inserting holes 14 to make the pyramid ends 210 further projected into the connecting cavity 13, with level arms 21a of the electrical terminals 20 being suspended under the insulating housing 10. The fastening ridges 211 of each electrical terminal 20 are designed to interfere with insides of the corresponding inserting hole 14 so as to avoid the electrical terminals 20 tottering with respect to the insulating housing 10 or falling off from the insulating housing 10 and firmly secure the electrical terminal 20 to the insulating housing 10.

The switching ball 30 is made of conductive materials and rollably placed in the receiving chamber 12 of the insulating housing 10, wherein the switching ball 30 can be supported by the ring-shaped step 15 to further project into the connecting cavity 13 so as to electrically contact with the pyramid ends 210 of the electrical terminals 20. The insulating cover 40 is covered on the insulating housing 10 to seal up the receiving chamber 12, so as to restrain the switching ball 30 in the insulating housing 10.

Referring to FIG. 5, the tilt switch is uprighted to realize a closed state, by means of the switching ball 30 resisting against the ring-shaped step 15 and further projecting into the connecting cavity 13 to simultaneously electrically connect with the four pyramid ends 210 of the four electrical terminals 20.

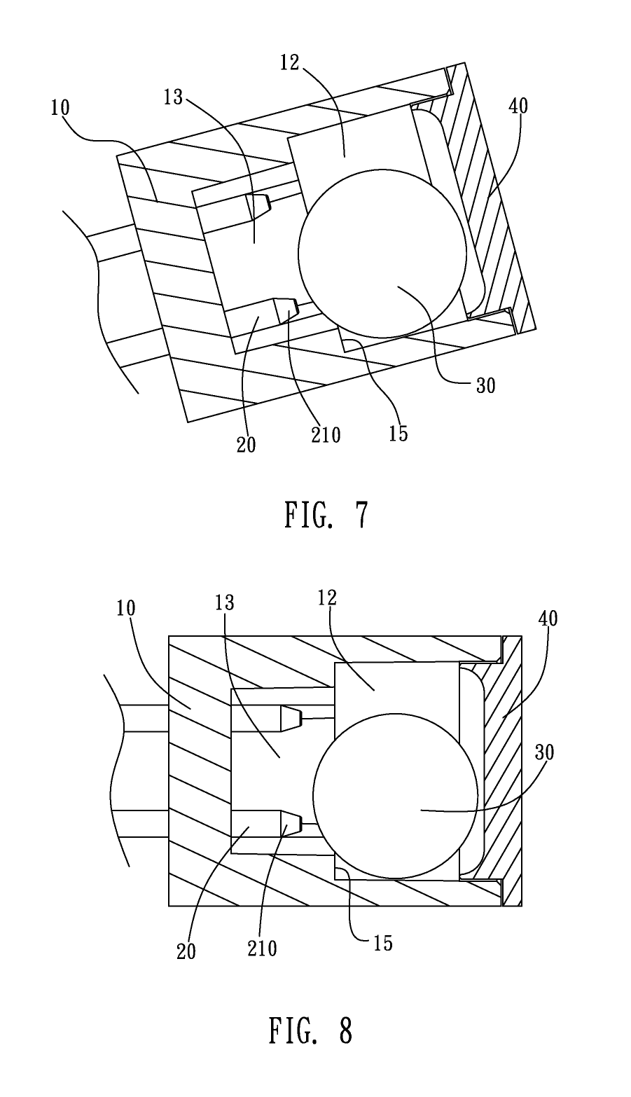

Referring to FIGS. 6-8, the tilt switch is tilted sideward to drive the switching ball 30 to roll over the step 15 into the receiving chamber 12 so as to disconnect the switching ball 30 from the pyramid end 210 of at least one electrical terminal 20 for realizing an open state thereof, wherein the tilt switch is at the open state if only the switching ball 30 is disconnected from one of the electrical terminals 20.

As described above, the switching ball 30 of the tilt switch of the present invention needs to roll over the step 15 which has a harder span when the tilt switch changes working states thereof between the closed state and the open state. So, the working states of the tilt switch are not easily changed so that further improves operational reliability of the tilt switch.

What is claimed is:

1. A tilt switch, comprising:
an insulating housing having a receiving chamber in an upper portion thereof and a connecting cavity in a lower portion thereof, the connecting cavity being coaxially connected with the receiving chamber and being smaller than the receiving chamber in diameter to accordingly form a ring-shaped step between two vertical periphery surfaces of the connecting cavity and the receiving chamber, a bottom side of the connecting cavity defining a plurality of inserting holes each vertically penetrating through the insulating housing;
a plurality of electrical terminals inserted upward in the inserting holes respectively and further projecting into the connecting cavity;
a switching ball made of conductive materials and rollably placed in the receiving chamber of the insulating housing; and
an insulating cover removably covered on the insulating housing to seal up the receiving chamber and restrain the switching ball in the insulating housing,
wherein the ring-shaped step has a top face substantially perpendicular to the two vertical periphery surfaces of the connecting cavity and the receiving chamber, the switching ball needs to roll over the ring-shaped step having a hard span when the tilt switch changes working states thereof between a closed state which is realized by the switching ball further projecting into the connecting cavity to simultaneously electrically connect with the electrical terminals, and an open state which is realized by tilting the tilt switch to disconnect the switching ball from at least one electrical terminal.

2. The tilt switch as claimed in claim 1, wherein a part of each electrical terminal inserted in the inserting hole of the insulating housing is provided with fastening ridges therearound for interfering with insides of the corresponding inserting hole.
